(19) United States
(12) Patent Application Publication
(10) Pub. No.: US 2026/0362064 A1
(43) Pub. Date: Nov. 12, 2026

(54) NOISE REDUCTION WITH HEARING DEVICE

(71) Applicant: SONOVA AG, Staefa (CH)

(72) Inventors: Michael Kramer, Urbana, IL (US); Samuel Bucher, Rapperswil (CH); Andreas Kreuzmann, Männedorf (CH); Gregor Ochsner, Einsiedeln (CH); Jan Brunner, Stäfa (CH); Laura Jagoda, Zurich (CH); Nele Börsing, Stäfa (CH)

(21) Appl. No.: 19/571,275

(22) Filed: Mar. 18, 2026

Related U.S. Application Data
(63) Continuation-in-part of application No. 19/203,534, filed on May 9, 2025.

(51) Int. Cl. H04R 25/00; H04R 3/00; H04R 3/04

(52) U.S. Cl. CPC H04R 25/43; H04R 3/002; H04R 3/04

(57) ABSTRACT

A method for noise reduction with a hearing device comprises: receiving a first input signal from a first microphone of the hearing device and a second input signal from a second microphone of the hearing device; determining correlated components of the first input signal and the second input signal; and determining a noise reduced signal by dampening components in the first input signal different from the correlated components and/or by amplifying the correlated components in the first input signal.

### RELATED APPLICATIONS

The present application is a continuation-in-part of U.S. patent application Ser. No. 19/203,534, filed May 9, 2025, which is hereby incorporated by reference in its entirety.

### BACKGROUND INFORMATION

Hearing devices may be used for compensating hearing deficiencies of a user and may provide several features that aim to facilitate speech intelligibility, improve sound quality, reduce noise level or adjust general volume. Many functionalities are designed to benefit the user's hearing performance in very specific situations.

In some scenarios, undesirable friction noise (e.g., wind noise, motion-induced noise, etc.) can mask microphone input signals of hearing devices, which affects the perceptibility of target signals such as speech. As an illustrative example, wearing hearing devices in an outside environment can cause the input signals from the microphones to be masked by wind noise. The wind noise is dominantly from air pressure fluctuations on the microphones caused by local air turbulences around the hearing device. Usually, wind noise is dominant in frequencies below 1500 Hz.

Some hearing devices provide a wind noise canceller, which comprises a wind noise detector and a static high-pass filter. The wind noise detector determines when wind noise cancelling should be enabled, and the static high-pass filter then suppresses low frequency signals presumed to be dominated by noise. While this is a simple and effective solution, it may also affect target signals in their low frequencies and does not provide any noise cancelling benefit above the cutoff frequency.

Alternative solutions may be based on comparing the wind noise presence on two microphones of the hearing device and selecting the input signal which contains less wind noise.

As another illustrative example, hearing devices worn during physical activity, such as running, can experience motion-induced friction noise that can mask the input signals from the microphones and affect the perceptibility of target signals, resulting in an unnatural listening experience for the user. Such motion-induced friction noise may include mechanically induced artifacts typically caused from the user's hair, the user's skin, and/or other objects brushing against the hearing device. Such motion-induced friction noise is likewise typically dominant at low frequencies below 1500 Hz.

Accordingly, there is a need for improved hearing devices that provide a robust suppression of friction noise, including wind noise and motion-induced friction noise, while preserving target signals.

### BRIEF DESCRIPTION OF THE DRAWINGS

Below, embodiments are described in more detail with reference to the attached drawings.

FIG. 1 schematically shows a hearing device.

FIG. 2 schematically shows a functional diagram of a hearing device according to an embodiment.

FIGS. 3 and 4 show diagrams with auto-correlations and cross-correlations of input signals.

FIG. 5 shows a diagram with coherences during speech and wind noise.

FIGS. 6 and 7 show diagrams with an averaged power ratio of the input signals during speech and wind noise.

FIG. 8 schematically shows an illustrative implementation of a hearing system.

FIG. 9 schematically shows another illustrative implementation of a hearing system.

FIG. 10 schematically shows another illustrative implementation of a hearing system.

FIG. 11 shows an illustrative method for operating a hearing system.

FIG. 12 shows another illustrative method for operating a hearing system.

FIG. 13 shows an illustrative computing system.

The reference symbols used in the drawings, and their meanings, are listed in summary form in the list of reference symbols. In principle, identical parts are provided with the same reference symbols in the figures.

### DETAILED DESCRIPTION

Described herein are a method, computer program and computer-readable medium for wind noise reduction with a hearing device as well as to the hearing device.

It is a feature described herein to reduce a noise signal, such as friction noise, in an input signal of a hearing device. It is a further feature to increase speech understandability for hearing device users in windy situations and/or during physical activity.

A first aspect relates to a method for noise reduction with a hearing device. In general, a hearing device is adapted for receiving one or more audio signals, processing the one or more audio signals into a processed audio signal and outputting the processed audio signal to a user, i.e., the user wearing the hearing device. The one or more audio signals may be provided by microphones of the hearing device. The processed audio signal may be output by a loudspeaker of the hearing device, which also may be called receiver. The hearing device may be a hearing aid, which is a hearing device adapted for processing the one or more audio signals, such that a hearing loss of the user is compensated.

According to an embodiment, the method comprises: receiving a first input signal from a first microphone of the hearing device and a second input signal from a second microphone of the hearing device. The first microphone and the second microphone may be integrated into one housing of the hearing device. The input signals are audio signals and, when digitized, may be considered as audio streams, which may be digital data streams. Digital data streams comprise data, such as audio data, wherein the data values are associated with time values. The data values are timely ordered. All signals mentioned below may be considered as such data streams.

According to an embodiment, the method comprises: determining correlated components of the first input signal and the second input signal. The first microphone and the second microphone acquire sound of sound sources around the user. When exposed to wind, each microphone may acquire wind noise, however, the wind noise acquired by the first microphone and the wind noise acquired by the second microphone is usually weakly correlated. Additionally or alternatively, during physical activity, each microphone may acquire motion-induced friction noise that is likewise weakly correlated between the first microphone and the second microphone. Therefore, it is assumed that the correlated components of the first input signal and the second input signal are primarily from the desired sound sources. It follows that when components different from the correlated components are dampened, mainly friction noise is dampened in the respective input signal. Also, when the correlated components in the first input signal are amplified, then the desired sound sources are correspondingly amplified. The components may be frequency ranges and/or frequency bins of the respective input signal.

The term component may refer to a frequency component and/or a frequency band of the respective input signal.

A noise reduced signal, which is further processed by the hearing device, may be determined from the first input signal or the second input signal.

According to an embodiment, the method comprises: determining the noise reduced signal based on receiving a motion signal from a motion sensor included in the hearing device and determining that the motion signal exceeds a motion threshold. The motion threshold may be representative of motion of the hearing device when a user of the hearing device is performing physical activity such as walking. Such physical activity may be indicative of the presence of motion-induced friction noise to be suppressed by the noise reduced signal.

According to an embodiment, the method comprises: determining the noise reduced signal based on detecting wind noise using a wind noise detector.

In this manner, the noise reduced signal is determined based on detecting physical activity and/or wind noise.

According to an embodiment, the method comprises: determining a first noise reduced signal by dampening components in the first input signal different from the correlated components and/or by amplifying the correlated components in the first input signal. In particular, frequency ranges and/or frequency bins of the respective input signal may be damped. This may mean that the amplitude of the signal in the frequency range and/or frequency bin is reduced.

According to an embodiment, the method comprises: determining a second noise reduced signal by dampening components in the second input signal different from the correlated components and/or by amplifying the correlated components in the second input signal. The components in the second input signal different from the correlated components may be uncorrelated components.

According to an embodiment, the method comprises: selecting the first noise reduced signal or the second noise reduced signal to output as the noise reduced signal. For example, in a main mode, the second noise reduced signal is selected to output as the noise reduced signal. Alternatively, in a fallback mode, the first noise reduced signal is selected to output as the noise reduced signal. Alternatively, the first noise reduced signal may be selected when the first noise reduced signal has more correlated components than the second noise reduced signal or the second noise reduced signal may be selected when the second noise reduced signal has more correlated components than the first noise reduced signal.

According to an embodiment, the method comprises: determining a mixed noise reduced signal by mixing the first noise reduced signal and the second noise reduced signal. As a further possibility the noise reduced signal, which is further processed by the hearing device, is a mixture of the first noise reduced signal and the second noise reduced signal. Mixing may be performed by analyzing, which input signal contains lesser friction noise than the other signal and higher weighting the noise signal corresponding to the input signal with lesser friction noise.

According to an embodiment, the method comprises: determining a first auto-correlation of the first input signal, a second auto-correlation of the second input signal and a cross-correlation between the first input signal and the second input signal.

In general, a correlation may be determined by multiplication of the signal with itself (for auto-correlation) or by multiplication of the signals (for cross-correlation) in the frequency domain. The result may be smoothed by averaging. The input signals may be complex-valued signals. The cross-correlation may be the expectation value of the first input signal times the conjugate complex second input signal. The auto-correlation of an input signal may be the value of the square of the absolute value of the input signal. The auto-correlation may be real-valued. The cross-correlation may be complex-valued.

According to an embodiment, the first input signal and second input signal are transformed into the frequency domain. After the transformation, each input signal may be a complex-valued signal, which is composed of Fourier components of the input signal in the time domain.

According to an embodiment, the cross-correlation, the first auto-correlation and the second auto-correlation may be determined in the frequency domain. The cross-correlation, the first auto-correlation and the second auto-correlation may be determined per frequency band and/or frequency bin. There may be a cross-correlation, a first auto-correlation and a second auto-correlation for a plurality of frequency bands.

According to an embodiment, the cross-correlation, the first auto-correlation and second auto-correlation are averaged in the frequency domain.

According to an embodiment, the method comprises: determining a transfer function by dividing the cross-correlation by a weighted sum of the first auto-correlation and the second auto-correlation. The transfer function may be determined per frequency band and/or frequency bin. There may be a transfer function for a plurality of frequency bands.

According to an embodiment, the weighted sum of the first auto-correlation and the second auto-correlation is determined by multiplying the first auto-correlation with a first regularization coefficient and the second auto-correlation with a second regularization coefficient. With these regularization coefficients, the friction noise suppression can be tuned.

The transfer function may be seen as a quantity from which the correlated components may be derived. A magnitude of the complex-valued transfer function may provide a gain, which is higher for strongly correlated components and which is lower for weaker correlated components of the input signals.

Furthermore, a phase of the transfer function provides a phase response from the second microphone to the first microphone. The phase response may transform the second input signal to a signal, which can be compared with the first input signal.

According to an embodiment, the method comprises: determining a noise reduced signal by multiplying the first input signal and/or the second input signal with the transfer function or at least with a magnitude of the transfer function. In such a way, correlated components are amplified and uncorrelated components, i.e., components different from the correlated components, are dampened. Multiplication may be performed by frequency band.

According to an embodiment, a magnitude of the transfer function is limited from below with a minimal gain before multiplication with the first input signal and/or the second input signal. To reduce artifacts, magnitudes, which are below a threshold, i.e., the minimal gain, are set to the minimal gain.

According to an embodiment, a magnitude of the transfer function is limited from above with a maximal gain before multiplication with the first input signal and/or the second input signal. To reduce artifacts, magnitudes, which are above a threshold, i.e., the maximal gain, are set to the maximal gain. The maximal gain may be 1. In such a way, there is no amplification and solely not related components are dampened.

According to an embodiment, the method comprises: determining a first noise reduced signal by multiplying the first input signal with the transfer function, wherein a magnitude of the transfer function is limited from below with a minimal gain and limit from above with a maximal gain before multiplication with the second input signal. The first noise reduced signal may be based solely on dampening not correlated components.

According to an embodiment, the method comprises: determining a second noise reduced signal by multiplying the second input signal with the transfer function, wherein a magnitude of the transfer function is limited from below with a minimal gain. The first noise reduced signal may be based on dampening not correlated components and amplification of correlated components.

According to an embodiment, the method comprises: mixing the first noise reduced signal and the second noise reduced signal by: determining weights for the first noise reduced signal and the second noise reduced signal, and summing the first noise reduced signal and the second noise reduced signal weighted with the weights. The weights may be determined based on an analysis with respect to the amount of wind noise in the respective input signal and/or when there are signs of clipping in the respective signal. The lower the signal quality, the smaller the corresponding weight.

According to an embodiment, a first power of the first input signal in at least a frequency band and a second power of the second input signal in at least the frequency band are determined. The amount of friction noise may be determined from the first power and the second power. The first power and the second power may be determined over time. The frequency band may be the complete frequency range of the input signals or may be a band of one or a plurality of frequency bins.

According to an embodiment, a power ratio is determined from the first power and the second power, for example dividing the second power by the first power or vice versa. The weights may be determined from the power ratio. The power ratio may be an indicator at which microphone the wind noise is higher compared to the other microphone. The weights may be chosen, such that the signal with the higher friction noise is damped and the signal with the lower friction noise is amplified.

The weights may be 0 and 1, i.e. either the first noise reduced signal or the second noise reduced signal may be used as output signal.

According to an embodiment, the power ratio is averaged into an averaged power ratio, in particular with dual slope averaging, and the weights are determined from the averaged power ratio. The peaks of the power ratio may be tracked, for example by dual slope averaging. From the number and/or magnitude of the peaks, the weights may be determined. For example, when the average power ratio is higher as a threshold, the weight for first noise reduced signal may be chosen to be 1 (or alternatively 0) and the weight for the second noise reduced signal may be chosen to be 0 (or alternatively 1).

According to an embodiment, the first microphone is a front microphone and the second microphone is a back microphone of the hearing device. The hearing device may comprise a behind-the-ear part and an in-the-ear part. When worn by the user, the behind-the-ear part is located behind an ear of the user and the in-the-ear part is located inside the ear of the user. The first microphone and the second microphone may be integrated into a housing of the behind-the-ear part. The front microphone may be arranged in a top region of the behind-the-ear part. The back microphone may be arranged in a back region of the behind-the-ear part. The orientations top and back are understood with respect to the head of the user, when the hearing device is worn by the user.

According to an embodiment, the method comprises: further processing the noise reduced signal or the mixed noise reduced signal into a further processed signal. This may be performed with a sound processor of the hearing device, which may comprise one or more actuators. The actuators may be provided by software and/or hardware, such as a DSP, a processor, etc.

According to an embodiment, the method comprises: outputting the further processed signal to a user of the hearing device. The processed audio stream may be output by a loudspeaker, which may be arranged in an ear channel of the user.

According to an embodiment, the further processing comprises at least one of and/or the actuators are adapted for at least one of: frequency depending amplification, frequency shifting, frequency compressing, beam forming, noise cancelling.

A further aspect relates to a computer program for wind noise reduction with a hearing device, which, when being executed by at least one processor, is adapted to carry out the steps of the method such as described herein. For example, the computer program may be executed in the hearing device.

A further aspect relates to a computer-readable medium, in which such a computer program is stored. In general, a computer-readable medium may be a hard disk, a USB (Universal Serial Bus) storage device, a RAM (Random Access Memory), a ROM (Read Only Memory), an EPROM (Erasable Programmable Read Only Memory) or a FLASH memory. A computer-readable medium may also be a data communication network, e.g., the Internet, which allows downloading a program code. The computer-readable medium may be a non-transitory or transitory medium. The computer-readable medium may be a memory of the hearing device.

A further aspect relates to a hearing device with a first microphone, a second microphone, a sound output device, a noise canceller and a sound processor. The first microphone, the second microphone, the sound output device, the noise canceller and the sound processor may be integrated in a housing of the hearing device. The sound output device, such as a loudspeaker, may be integrated into the housing or may be connected via a cable with the housing. The hearing device is adapted for performing the method such as described herein.

It has to be understood that features of the method as described in the above and in the following may be features of the hearing device, computer program and the computer-readable medium as described in the above and in the following, and vice versa.

These and other aspects will be apparent from and elucidated with reference to the embodiments described hereinafter.

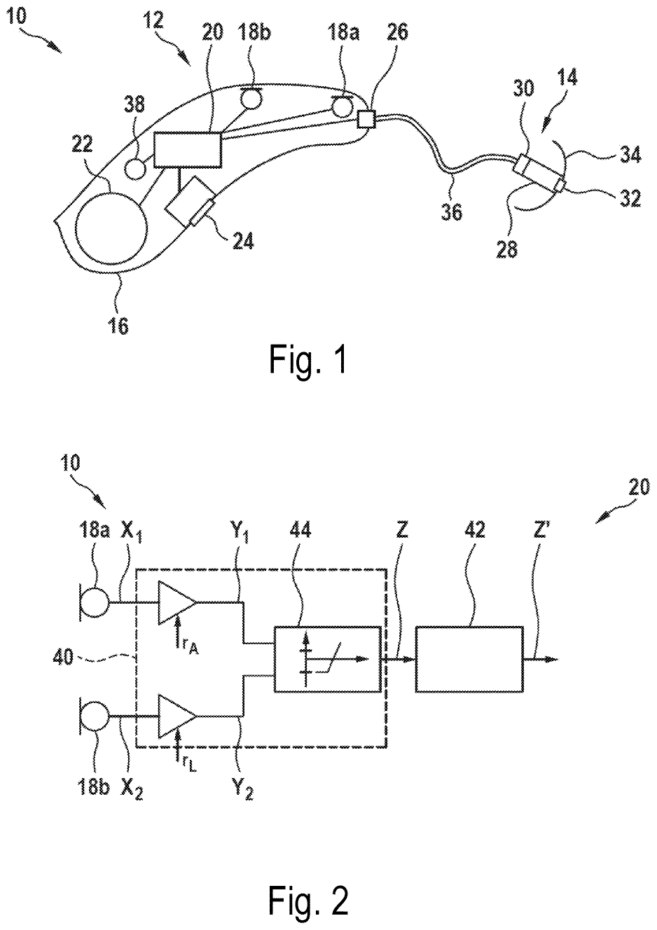

FIG. 1 shows a hearing device 10, in particular a hearing aid, which is composed of a behind-the-ear part 12 and an in-the-ear part 14.

The behind-the-ear part 12 has a housing 16 adapted to be carried behind the ear of a user. Two microphones 18a, 18b, a computing device 20, a battery 22, a knob 24 and a connector 26 are integrated into the housing 16. A front microphone 18a is located at a position of the housing 16 to be more exposed to sound received from a front direction of the user. A back microphone 18b is located at a position of the housing 16 to be more exposed to sound received from a back direction of the user. The computing device 20 is powered by the battery 22 and/or comprises a software processor, a signal processor and a memory. The knob can be actuated by a user and/or be used as user interface for switching the hearing device 10 on and off and for optionally changing settings of the hearing device 10.

The in-the-ear part 14 comprises a housing 28 adapted to be plugged into the ear channel of the user. A connector 30 and sound output device 32, like a loudspeaker and/or receiver, are integrated into the housing 28. The housing 28 comprises a dome 34 for occluding the ear channel. The in-the-ear part 14 is connected via a cable 36 with the behind-the-ear part 12, which cable 36 is connected to the connectors 26, 30.

There may be one or more further sensors 38, such as an acceleration sensor or health sensor, integrated into the housing 16.

The hearing device 10 acquires an audio input signal with each of the microphones 18a, 18b from an environment of the user. The computing device 20 processes the input signals into a processed audio signal, which is provided via the cable 36 to the sound output device 32 and output to the user.

FIG. 2 shows a functional diagram of the hearing device 10. Also a method performed by the hearing device 10 and in particular the computing device 20 will be described with respect to FIG. 2. It is shown that the computing device 20 comprises a noise canceller 40 and a sound processor 42.

The noise canceller 40 receives a first input signal X₁ from the microphone 18a of the hearing device 10 and a second input signal X₂ from the microphone 18b of the hearing device 10. The noise canceller 40 uses both the front microphone 18a and the back microphone 18b and processes their input signals X₁, X₂. In general, input signals X₁, X₂ from at least two acoustically separated microphones 18a, 18b are used for signal analysis and filtering.

The time domain input signals X₁, X₂ from the microphones 18a, 18b are converted in the frequency domain resulting in a first input signal X₁ in the frequency domain from the front microphone 18a and second input signal X₂ in the frequency domain from the back microphone 18b. Both input signals X₁, X₂ can be seen as vectors composed of complex values, which may be seen as Fourier coefficients of the time domain signals.

The following processing of the input signals X₁, X₂ is done in the frequency domain. It is possible that the processing is done in separate sub-bands. In general, the processing may be done broadband or based on a plurality of frequency bands.

At next, the noise canceller 40 analyzes the correlation of the input signals X₁, X₂ of the two microphones 18a, 18b of the hearing device 10 to determine and remove wind noise components of the input signals X₁, X₂, while retaining the desired speech.

The noise canceller 40 determines correlated components of the first input signal X₁ and the second input signal X₂. After that, the noise canceller 40 determines a first noise reduced signal Y₁ by dampening components in the first input signal X₁ different from the correlated components and/or by amplifying the correlated components in the first input signal X₁. The noise canceller 40 further determines a second noise reduced signal Y₂ by dampening components in the second input signal X₂ different from the correlated components and/or by amplifying the correlated components in the second input signal X₂.

To this end, a cross-correlation

$$E [ {X}_{1} {X}_{2}^{*} ]$$

of the two input signals X₁, X₂, a first auto-correlation E[|X₁|²] of the first input signal X₁ and a second auto-correlation E[|X₂|²] of the second input signal X₂ are calculated. The function E[X] denotes the expectation value of the vector X. However, it is possible that the calculation of the expectation value E[X] is replaced by a calculation of an average value, which determines the average of the vector X. The cross-correlation

$$E [ {X}_{1} {X}_{2}^{*} ] ,$$

the first auto-correlation E[|X₁|²] and second auto-correlation E[|X₂|²] may be determined by averaging in the frequency domain.

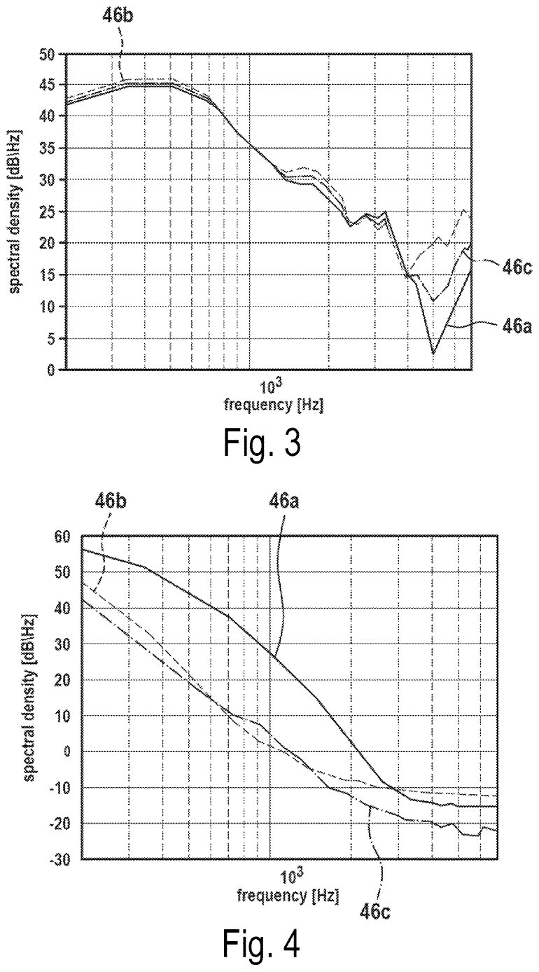

In some examples, components in the first input signal and/or the second input signal that are different from the correlated components are caused by wind noise. For example, FIGS. 3 and 4 show auto-correlations 46a, 46b and cross-correlations 46c of the input signals X₁, X₂ of the microphones during speech (FIG. 3) and during wind noise (FIG. 4).

The curve 46a shows the first auto-correlation E[|X₁|²] of the first input signal X₁ with respect to the frequency. The curve 46b shows the second auto-correlation E[|X₂|²] of the second input signal X₂ with respect to the frequency. The curve 46c shows the cross-correlation

$$E [ {X}_{1} {X}_{2}^{*} ]$$

of the two input signals X₁, X₂ with respect to the frequency. From the cross-correlation

$$E [ {X}_{1} {X}_{2}^{*} ]$$

and the auto-correlations [|X₁|²], E[|X₂|²] of the input signals X₁, X₂ of the microphones 18a, 18b, a complex-valued coherent transfer function R from the back microphone 18b to the front microphone 18a is calculated by

$$R = \frac{E [ {X}_{1} {X}_{2}^{*} ]}{{ρ}_{1} E [ {\vert {X}_{1} \vert}^{2} ] + ( 1 + {ρ}_{2} ) E [ {\vert {X}_{2} \vert}^{2} ]}$$

The transfer function R is determined by dividing the cross-correlation

$$E [ {X}_{1} {X}_{2}^{*} ]$$

by a weighted sum of the first auto-correlation E[|X₁|²] and the second auto-correlation E[|X₂|²]. R is not a normalized cross-correlation as defined in the literature, in which variances would be used in the denominator, but it is rather a transfer function estimate.

The weighted sum of the first auto-correlation E[|X₁|²] and the second auto-correlation E[|X₂|²] is determined by multiplying the first auto-correlation E[|X₁|²] with a first regularization coefficient ρ₁ and the second auto-correlation E[|X₂|²] with a second regularization coefficient ρ₂. The regularization coefficients ρ₁ and ρ₂ in the weighted sum may be fixed values and/or which may be tuned to suppress wind noise as strong as possible.

The transfer function R is determined by dividing the cross-correlation

$$E [ {X}_{1} {X}_{2}^{*} ]$$

by a weighted sum of the first auto-correlation E[|X₁|²] and the second auto-correlation E[|X₂|²].

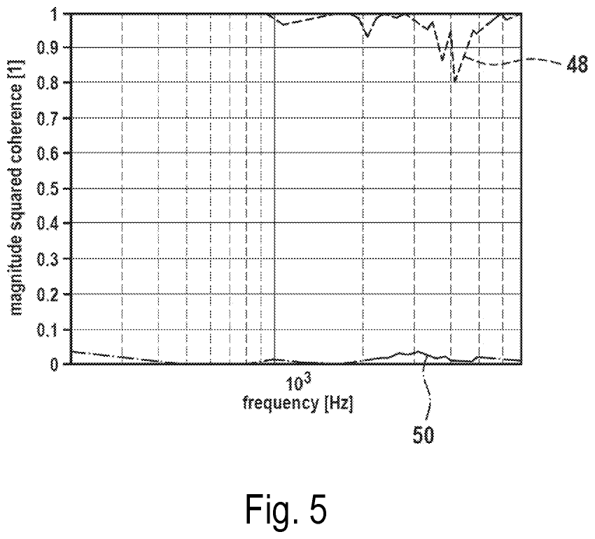

FIG. 5 shows curves 48, 50 with a magnitude of the squared coherence of the input signals X₁, X₂ from the microphones 18a, 18b. This magnitude is also provided by the transfer function R. The curve 48 shows the magnitude during speech, where the magnitude is near 1, and the curve 50 shows the magnitude during wind noise, where the magnitude is near 0. It can be seen that the transfer function R is a good indicator for detecting wind noise.

In some examples, the transfer function R may additionally or alternatively be determined for suppressing motion-induced friction noise. The parameters used to determine the transfer function R for motion-induced friction noise may be the same and/or different from the parameters used to determine the transfer function R for wind noise. For example, the regularization coefficients ρ₁ and ρ₂ in the weighted sum may be fixed values and/or which may be tuned to suppress motion-induced friction noise as strong as possible.

Returning to FIG. 2, the noise reduced signal Y₁, Y₂ are then determined by multiplying the first input signal X₁ and the second input signal X₂ with the transfer function R, from which, however, the phase may be removed and/or its magnitude may be adapted.

For this, a real-valued gain r=|R| and a phase factor R/r is computed from the complex-valued coherent transfer function R.

For determining the noise reduced signal Y₂, the gain r is limited from below to reduce artifacts to a limited gain r_{L}=max(r, r_{M}). The maximal attenuation r_{M} or the minimal gain r_{M} may be a fixed value and/or may be tuned to reduce artifacts as strong as possible.

The limited gain r_{L} is applied to the input signal X₂ of the back microphone 18b by multiplication.

Additionally, the phase factor R/r is multiplied to the input signal X₂ of the back microphone 18b to map the input signal X₂ to the front microphone 18a. As will be shown below, the phase factor R/r may provide the projection of the input signal X₂ from the back microphone 18b to the input signal X₁ of the front microphone 18a.

The result is a noise reduced signal Y₂.

For determining the noise reduced signal Y₁, the limited gain r_{L} is further limited from above to an attenuation gain r_{A}=min(r, r_{H}). For example, r_{H}=1. In such a way, the gain is limited to attenuation only and/or the projection from the back microphone 18b to the front microphone 18a may be removed for the most part.

The attenuation gain r_{A} is applied to the input signal X₁ of the back microphone 18b by multiplication, resulting in a noise reduced signal Y₁.

In general, a magnitude r of the transfer function R is limited from below with a minimal gain r_{L} before multiplication with the first input signal X₁ and/or the second input signal X₂.

For determining the first noise reduced signal Y₁, the magnitude r of the transfer function R is limited from below with a minimal gain r_{L} and limit from above with a maximal gain r_{H} before multiplication with the first input signal X₁.

For determining the second noise reduced signal Y₂, the magnitude r of the transfer function R is limited from below with a minimal gain r_{L}.

After that, the noise canceller 40 determines a mixed noise reduced signal Z by mixing the first noise reduced signal Y₁ and the second noise reduced signal Y₂. For this, the noise canceller 40 comprises a mixer 44, which estimates which of the first input signal X₁ and the second input signal X₂ contains lesser wind noise.

The first noise reduced signal Y₁ and the second noise reduced signal Y₂ may be mixed by determining weights for the first noise reduced signal Y₁ and the second noise reduced signal Y₂ and summing the first noise reduced signal Y₁ and the second noise reduced signal Y₂ weighted with the weights.

For example, a weight w between 0 and 1 is determined and the noise reduced signal Y₁ and the noise reduced signal Y₂ are mixed with this weight.

Z=wY₁+(1−w)Y₂

The result is a wind noise reduced signal Z, which can be further processed by the hearing device 10. It is also possible that the weight w is solely 0 and 1.

It may be that the second noise reduced signal Y₂, i.e. the signal from the back microphone 18b is used as wind noise reduced signal Z. The mixer 44 may provide a main mode, in which the weight w is 0 and a fallback mode, in which the weigh t w is 1. In the fallback mode, the first noise reduced signal Y₁, from the front microphone 18a is output as wind noise reduced signal Z.

Mixing and/or the fallback mode may be necessary, because the second noise reduced signal Y₂ from the back microphone 18b may not always be less affected by wind noise, when compared to the first noise reduced signal Y₁ from the front microphone 18a. To illustrate, when wind arrives directly from the rear, it may be that one can hear annoying click noise artifacts in the signal Y₂ from the back microphone 18b, which are not audible in the signal Y₁ from the front microphone 18a under the same conditions. One of the purposes of the mixer 44 is to detect exactly these click noises and/or to trigger the fallback mode, in such cases.

The mixer 44 determines a first power of the first input signal X₁ in at least a frequency band and a second power of the second input signal X₂ in at least the frequency band. The first power and the second power are functions over time and/or in the time domain. The mixer 44 measures the front and the back microphone power in a certain frequency band, for example the sum over a range of specific frequency bins.

After that the mixer 44 determines a power ratio by dividing the second power by the first power or vice versa. The power ratio is a function over time and/or in the time domain. Optionally, the power ratio is normalized using a constant factor and/or limited to the range of [0, 1]. The power ratio is then averaged into an averaged power ratio and after that is optionally smoothed. The result is compared to a threshold. When the result is higher (or alternatively lower) than a threshold, the weight w is set to 1. When the result is lower (or alternatively higher) than the threshold, the weight w is set to 0. Below the threshold, the default mode may be used and above the threshold, fallback mode is used, (or vice versa).

Averaging may be done with dual slope averaging. With dual slope averaging the peaks of the power ratio may be tracked. With dual slope averaging in an integration phase, the power ration may be integrated (or summed). The resulting signal ramps up or down in response to the input signal. In a de-integration phase after the integration phase, a reference signal may be applied to the integrated signal, and the integrated signal discharges at a known rate until it returns to zero. In dual slope averaging, integration and de-integration is performed two times.

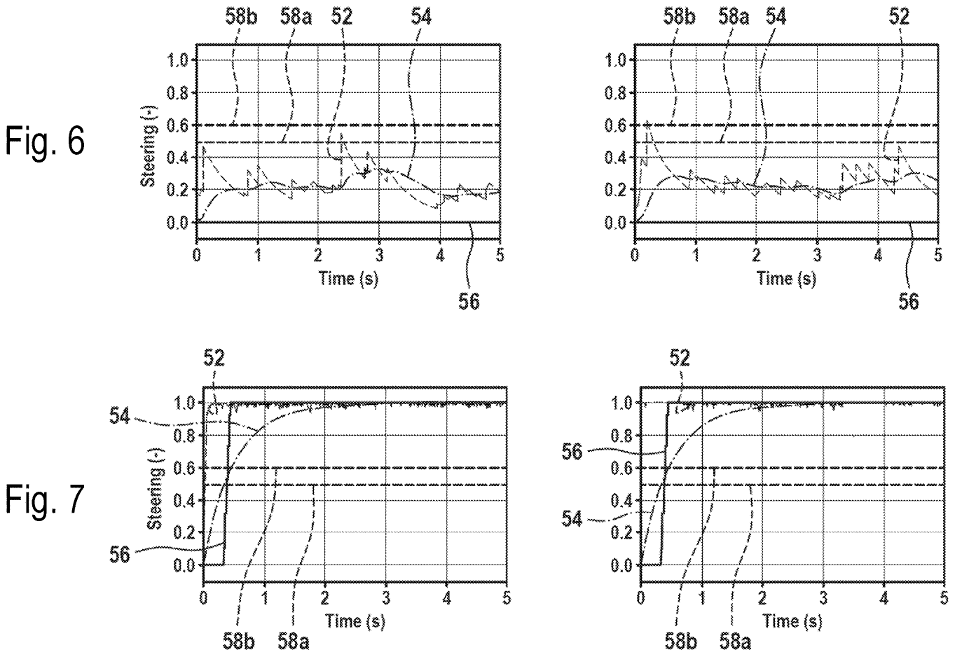

FIGS. 6 and 7 show diagrams with an averaged power ratio 52, which was determined by dual slope averaging of the power ratio of the input signals X₁ and X₂. FIG. 6 is an example with wind from the front and FIG. 7 is an example with wind from the back. The left-hand side panels show the curves for the left hearing device 10, i.e. for the left ear. The right-hand side panels show the curves for the right hearing device 10, i.e. for the right ear.

FIGS. 6 and 7 furthermore show the smoothed averaged power ratio 54 and the weight w, 56 over time.

In FIGS. 6 and 7 also an embodiment with a lower threshold 58a and an upper threshold 58b is shown. When the power ratio 54 is below the lower threshold 58a, then the weight w, 56 is 0. When the power ratio 54 is above the upper threshold 58b, then the weight w, 56 is 1. In between the thresholds, the weight w, 56 is between 0 and 1.

The noise reduced signal Z is then input into a sound processor 42 of the hearing device 10, which further processes the noise reduced signal Z into a further processed signal Z′. The further processed signal Z′ is output to the user of the hearing device 10 via the sound output device 32. The sound processor 42 may be adapted for frequency depending amplification, frequency shifting, frequency compressing, beam forming and/or noise cancelling.

To gain insight into the functionality of the coherent transfer function R such as defined above in context of wind noise cancelation, the following statistical model is assumed:

X₁=H₁S+N₁

X₂=H₂S+N₂

where X₁, X₂ are the frequency domain signals, H₁, H₂ are the transfer functions from the source to the front microphone 18a and the back microphone 18b, for example the respective head related transfer function depending on the location/direction of the source). S is the source signal and N₁, N₂ are the (wind) noise signals in the respective input signal X₁, X₂.

It is then assumed that the source signal S is independent of as well as uncorrelated and incoherent with respect to the wind noise signals N₁, N₂, i.e.,

$$E [ {SN}_{1}^{*} ] = 0 and E [ {SN}_{2}^{*} ] = 0 .$$

It is further assumed that the wind noise signals N₁, N₂ are also independent of as well as uncorrelated and incoherent with respect to each other, i.e.,

$$E [ {N}_{2} {N}_{1}^{*} ] = 0 .$$

Then, the correlation as used in the coherent transfer function R can be evaluated as follows:

$$E [ {X}_{1} {X}_{2}^{*} ] = E [ ( {H}_{1} S + {N}_{1} ) {( {H}_{2} S + {N}_{2} )}^{*} ] = {H}_{1} {H}_{2}^{*} E [ {\vert S \vert}^{2} ]$$

$$E [ {\vert {X}_{1} \vert}^{2} ] = E [ ( {H}_{1} S + {N}_{1} ) {( {H}_{1} S + {N}_{1} )}^{*} ] = {\vert {H}_{1} \vert}^{2} E [ {\vert S \vert}^{2} ] + E [ {\vert {N}_{1} \vert}^{2} ]$$

$$E [ {\vert {X}_{2} \vert}^{2} ] = E [ ( {H}_{2} S + {N}_{2} ) {( {H}_{2} S + {N}_{2} )}^{*} ] = {\vert {H}_{2} \vert}^{2} E [ {\vert S \vert}^{2} ] + E [ {\vert {N}_{2} \vert}^{2} ]$$

### Resulting in

$$R = \frac{{H}_{1} {H}_{2}^{*} E [ {\vert S \vert}^{2} ]}{\begin{matrix}{ρ}_{1} ( {\vert {H}_{1} \vert}^{2} E [ {\vert S \vert}^{2} ] + E [ {\vert {N}_{1} \vert}^{2} ] ) + \\ ( 1 + {ρ}_{2} ) ( {\vert {H}_{2} \vert}^{2} E [ {\vert S \vert}^{2} ] + E [ {\vert {N}_{2} \vert}^{2} ] )\end{matrix}}$$

or slightly reformulated

$$R = \frac{{H}_{1}}{{H}_{2}} \frac{{\vert {H}_{2} \vert}^{2} E [ {\vert S \vert}^{2} ]}{\begin{matrix}{ρ}_{1} ( {\vert {H}_{1} \vert}^{2} E [ {\vert S \vert}^{2} ] + E [ {\vert {N}_{1} \vert}^{2} ] ) + \\ ( 1 + {ρ}_{2} ) ( {\vert {H}_{2} \vert}^{2} E [ {\vert S \vert}^{2} ] + E [ {\vert {N}_{2} \vert}^{2} ] )\end{matrix}}$$

where the first factor

$$\frac{{H}_{1}}{{H}_{2}}$$

is a projection of the source signal S from X₂ to X₁ and the second term is a real-valued gain depending on the level of the source signal S at X₁ and X₂ and as well as the wind noise levels.

Removing the regularization by setting ρ₁=ρ₂=1 leads to

$$R \approx \frac{{H}_{1}}{{H}_{2}} \frac{{\vert {H}_{2} \vert}^{2} E [ {\vert S \vert}^{2} ]}{{\vert {H}_{2} \vert}^{2} E [ {\vert S \vert}^{2} ] + E [ {\vert {N}_{2} \vert}^{2} ]} = \frac{{H}_{1}}{{H}_{2}} \hat{W}$$

which is a combination of the projection

$$\frac{{H}_{1}}{{H}_{2}}$$

of the source signal S from X₂ to X₁ and a Wiener filter Ŵ at X₂. The Wiener filter Ŵ can be described by

$$\hat{W} = {arg}_{W} min E [ {‖ ( {H}_{2} S + {N}_{2} ) - {H}_{2} S ‖}_{2} ]$$

where the desired signal is H₂S and the noisy signal is H₂S+N₂ minimizing the Wiener filter Ŵ.

In summary, the coherent transfer function R can be decomposed into a projection

$$\frac{{H}_{o}}{{H}_{1}}$$

of the back microphone 18b to the front microphone 18a and a real-valued Wiener gain.

The projection

$$\frac{{H}_{o}}{{H}_{1}}$$

may be seen as a difference of the head-related transfer functions from the source to the back microphone 18b and to the front microphone 18a. This projection can be determined by calculating the phase or argument of the complex value R.

The Wiener gain can be seen as the coherent signal divided by the coherent and incoherent signal at the back microphone 18b, when assuming that the coherent signal is the target signal and the incoherent signal shall be suppressed. The Wiener gain can be determined by calculating the magnitude or absolute value of the complex value R. In some examples, the Wiener gain may likewise be determined for minimizing motion-induced friction noise signals.

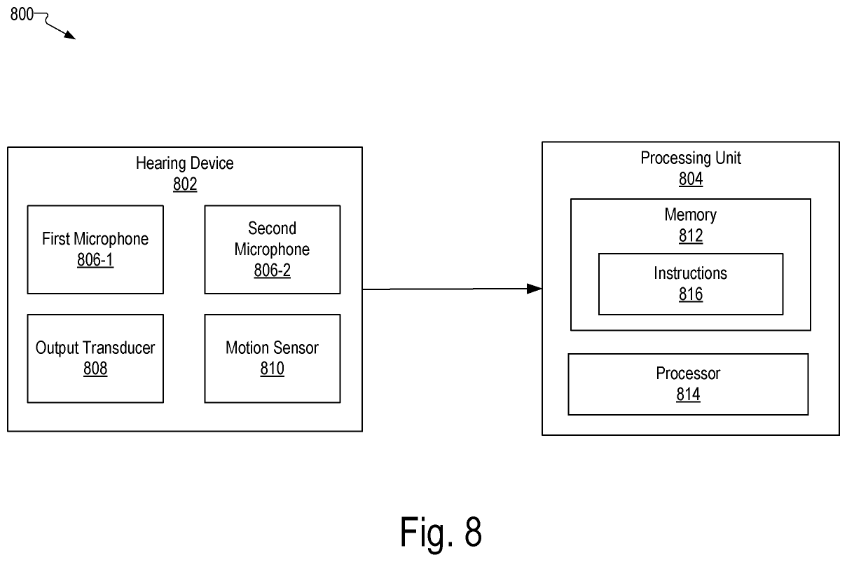

FIG. 8 shows an illustrative implementation 800 of a hearing system configured to determine a noise reduced signal that suppresses friction noise signals and/or amplifies target signals (e.g., speech) included in the input signals. As shown, implementation 800 includes a hearing device 802 communicatively coupled with a processing unit 804. Implementation 800 may include additional or alternative components as may serve a particular implementation.

Hearing device 802 may implement or be similar to hearing device 10. For example, hearing device 802 may be implemented by any type of hearing device configured to enable or enhance hearing by a user wearing hearing device 802. To illustrate, hearing device 802 may be implemented by a hearing aid configured to provide an amplified version of audio content to a user, a sound processor included in a cochlear implant system configured to provide electrical stimulation representative of audio content to a user, a sound processor included in a bimodal hearing system configured to provide both amplification and electrical stimulation representative of audio content to a user, or any other suitable hearing prosthesis.

As shown, hearing device 802 includes a first microphone 806-1, a second microphone 806-2, an output transducer 808, and a motion sensor 810. Hearing device 802 may include additional or alternative components as may serve a particular implementation. Other components may comprise, e.g., at least one of a battery, a power management, a computer processing device, a memory, a communication interface (e.g., a Bluetooth radio), and a user interface (e.g., a push button) to control the hearing device 802.

First microphone 806-1 may be implement or be similar to front microphone 18a and second microphone 806-2 may implement or be similar to back microphone 18b. For example, microphones 806 (e.g., first microphone 806-1 and second microphone 806-2) may be implemented by one or more suitable audio detection devices configured to detect an audio signal presented to a user of hearing device 802. The audio signal may include, for example, audio content (e.g., music, speech, noise, etc.) generated by one or more audio sources included in an environment of the user. Microphones 806 may be included in or communicatively coupled to hearing device 802 in any suitable manner. Output transducer 808 may be implemented by any suitable audio output device, for instance a loudspeaker of a hearing device or an output electrode of a cochlear implant system.

Motion sensor 810 may be any suitable sensor configured to detect motion, such as motion of hearing device 802, which may be indicative of motion of the user while wearing hearing device 802. In some examples, motion sensor 810 can include an accelerometer and/or a gyroscope and/or a magnetometer and/or an inertial measurement unit (IMU). Motion sensor 810 is further configured to output a motion signal representative of the motion detected by motion sensor 810. To illustrate, the motion signal can include data that is representative of one or more of an acceleration, an angular velocity, and/or an orientation associated with motion sensor 810. As shown, motion sensor 810 is included in hearing device 802. Alternatively, motion sensor 810 may be included in a different device (e.g., a watch or a mobile device worn or carried by the user). In these alternative configurations, hearing device 802 may access the motion signal generated by motion sensor 810 by being communicatively coupled to the different device.

Processing unit 804 may be implemented by one or more computing devices (e.g., computing device 20) and/or computer resources (e.g., processors, memory devices, storage devices, etc.) as may serve a particular implementation. For example, processing unit 804 may be implemented by a mobile device, personal computer, and/or other computing device configured to be communicatively coupled (e.g., by way of a wired and/or wireless connection) to hearing device 802. As shown, processing unit 804 may include, without limitation, a memory 812 and a processor 814 selectively and communicatively coupled to one another. Memory 812 and processor 814 may each include or be implemented by computer hardware that is configured to store and/or process computer software. Various other components of computer hardware and/or software not explicitly shown in FIG. 8 may also be included within processing unit 804. In some examples, memory 812 and/or processor 814 may be distributed between multiple devices and/or multiple locations as may serve a particular implementation.

Memory 812 may store and/or otherwise maintain executable data used by processor 814 to perform any of the functionality described herein. For example, memory 812 may store instructions 816 that may be executed by processor 814. Memory 812 may be implemented by one or more memory or storage devices, including any memory or storage devices described herein, that are configured to store data in a transitory or non-transitory manner. Instructions 816 may be executed by processor 814 to cause processing unit 804 to perform any of the functionality described herein. Instructions 816 may be implemented by any suitable application, software, code, and/or other executable data instance. Additionally, memory 812 may also maintain any other data accessed, managed, used, and/or transmitted by processor 814 in a particular implementation.

Processor 814 may be implemented by one or more computer processing devices, including general purpose processors (e.g., central processing units (CPUs), graphics processing units (GPUs), microprocessors, etc.), special purpose processors (e.g., application specific integrated circuits (ASICs), field-programmable gate arrays (FPGAs), etc.), image signal processors, digital signal processors, deep neural network (DNN) acceleration processors, or the like. Using processor 814 (e.g., when processor 814 is directed to perform operations represented by instructions 816 stored in memory 812), processing unit 804 may perform various operations as described herein.

In some other implementations, various computer processing devices, which may be included in processor 814 of processing unit 804, may also be distributed between hearing device 802 and the computing device communicatively coupled to hearing device 802. E.g., hearing device 802 may include computer processing devices such as a digital signal processor and/or a control processor and/or a deep neural network (DNN) acceleration processor, and the computing device communicatively coupled to hearing device 802 may include at least an additional computing device. Further, memory 812 of processing unit 804, may also be implemented as various memory devices distributed between hearing device 802 and the computing device communicatively coupled to hearing device 802.

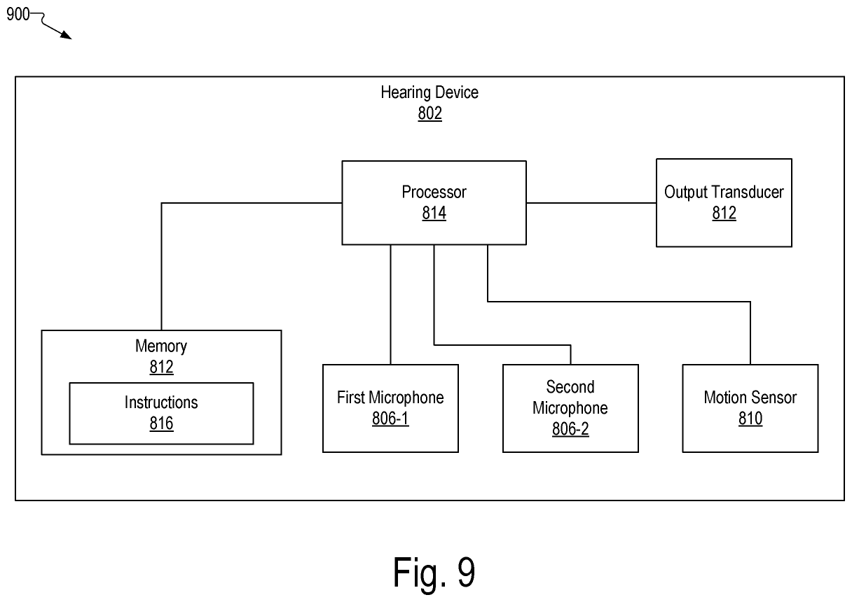

FIG. 9 shows another illustrative implementation 900 of a hearing system configured to determine a noise reduced signal that suppresses friction noise signals and/or amplifies target signals (e.g., speech) included in the input signals. As shown, implementation 900 is similar to implementation 800, except that implementation 900 includes processor 814 and memory 812 located within hearing device 802. Implementation 900 may include additional or alternative components as may serve a particular implementation.

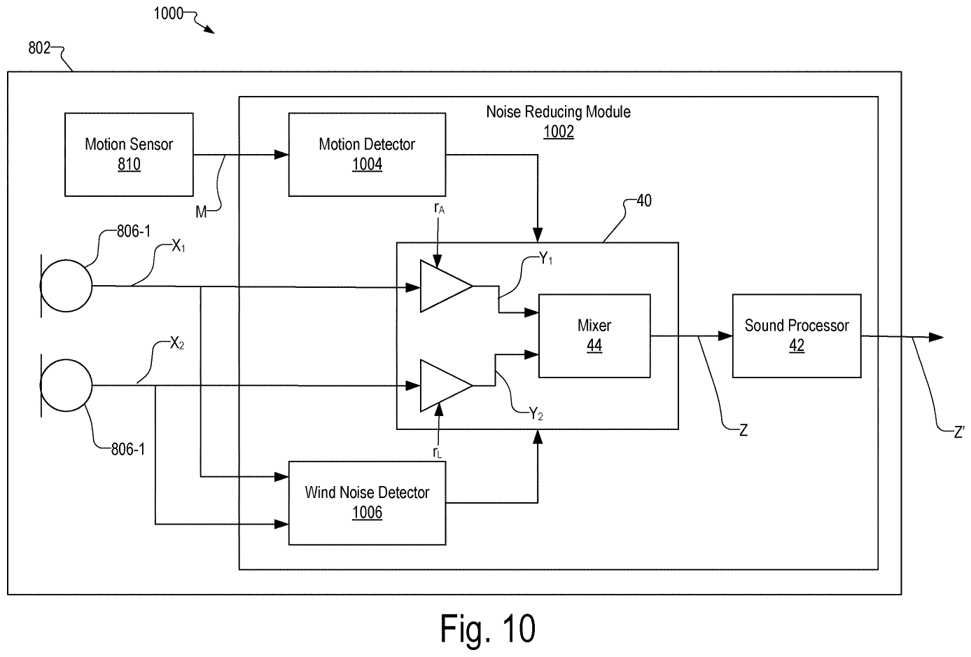

FIG. 10 shows another illustrative implementation 1000 of a hearing system configured to determine a noise reduced signal that suppresses friction noise signals and/or amplifies target signals (e.g., speech) included in the input signals. As shown, implementation 1000 is similar to implementation 900, except that implementation 1000 includes a noise reducing module 1002 that includes a motion detector 1004, a wind noise detector 1006, noise canceller 40, and sound processor 42. Noise reducing module 1002 may be implemented by one or more components of the hearing system (e.g., computing device 20, noise canceller 40, processing unit 804, and/or processor 814). Implementation 1000 may include additional or alternative components as may serve a particular implementation.

Noise reducing module 1002 is configured to receive first input signal X₁ from the first microphone 806-1 of the hearing device 802 and second input signal X₂ from the second microphone 806-2 of the hearing device 802.

Motion detector 1004 is configured to receive a motion signal M generated by motion sensor 810 and determine, based on the motion signal M, whether the user wearing hearing device 802 is performing physical activity (e.g., walking, running, jogging, dancing, etc.) likely to cause motion-induced friction noise. Such motion-induced friction noise may include mechanically induced artifacts, such as noise caused by irregular external impacts on microphones 806. To illustrate, the motion-induced friction noise may include, but is not limited to, one or more of: hair-contact noise (e.g., noise arising from the user's hair interacting with (e.g., rubbing against) hearing device 802 and/or another object), skin-contact noise (e.g., noise arising from the user's skin interacting with hearing device 802 and/or another object, such as device contact with the user's head during movement), object-contact noise (e.g., noise arising from an object (e.g., clothing, glasses, etc.) interacting with hearing device 802 and/or another object), hearing device component-contact noise (e.g., noise arising from structural components (e.g., housing, battery, cables, etc.) of hearing device 802 interacting with each other), etc. Such motion-induced friction noise is likely to occur (e.g., continuously or intermittently) while the user is performing physical activity. As an illustrative example, a repetitive motion of walking may cause repetitive noise artifacts from the user's hair brushing against microphones 806 of hearing device 802 during the repetitive motion. Accordingly, motion detector 1004 may process and/or analyze one or more parameters (e.g., a frequency, an amplitude, a variance, a periodicity, a temporal pattern, etc.) of the motion signal M that are indicative of the user performing physical activity that is likely to cause motion-induced friction noise.

In some examples, motion detector 1004 may compare the one or more parameters of the motion signal M to a motion threshold and, in instances where the one or more parameters of the motion signal M exceeds the motion threshold, determine that the user wearing hearing device 802 is performing physical activity likely to cause motion-induced friction noise. As an illustrative example, the motion threshold may be designated as a level of frequency representative of motion when the user is walking, such as at a frequency between about 0.8 Hz and about 2.5 Hz, such as a frequency between about 1 Hz and about 2 Hz, such as a frequency greater than about 1 Hz. Accordingly, when the motion signal M includes a frequency that is greater than the frequency level of the motion threshold, motion detector 1004 may determine that the user is at least walking and thereby performing physical activity likely to cause motion-induced friction noise. The motion detector 1004 may operate continuously or intermittently during the operation of the hearing system 800 and may process the motion signal M using one or more signal-processing mechanisms, such as temporal smoothing, hysteresis, and/or debounce mechanisms. For example, motion detector 1004 may determine that the user is performing physical activity when the motion signal M exceeds the motion threshold for a duration of time (e.g., at least 10 seconds, at least 30 seconds, at least 1 minute, at least 2 minutes, at least 10 minutes, etc.).

While the illustrated example included setting the motion threshold to a threshold indicative of a frequency of the user walking, the motion threshold may be set to a threshold indicative of other types of parameters (e.g., amplitude, variance, a periodicity, a temporal pattern, etc.) and/or other types of physical activities (e.g., jogging, running, exercising, dancing, etc.). Moreover, the motion threshold may be fixed such that the motion threshold remains constant during operation of hearing device 802. Alternatively, the motion threshold may be adjustable, such as to account for differences in sensor characteristics, device placement, and/or motion associated with a particular user. To illustrate, the motion threshold may be refined over time based on an individual user's movement behavior. In some examples, the motion threshold may be designated by motion detector 1004, such as based on one or more parameters indicative of physical activity of the user and/or other users. Alternatively, the motion threshold may be designated and/or adjusted by the user.

Still other suitable configurations and/or methods may be used by noise reducing module 1002 to determine when the user is performing physical activity likely to cause motion-induced friction noise. For example, noise reducing module 1002 may be configured to receive data representative of a location of the user (e.g., by a global positioning system (GPS)) and/or a time of day (e.g., by a clock) and/or a physiological parameter (e.g., heart rate, blood pressure, respiratory rate, temperature, etc.) of the user (e.g., by a physiological sensor) for determining when the user is performing physical activity. Additionally or alternatively, the input signals X₁, X₂ may include a voice input from the user, which may allow the user to vocalize when the user is performing physical activity. In some implementations, the hearing system may be configured to request voice input from the user regarding the physical activity of the user (e.g., by a mobile device or other user interface).

In instances where motion detector 1004 determines that the user is performing physical activity, motion detector 1004 may be configured to activate noise canceller 40 to generate the noise reduced signal Z. For example, noise canceller 40 may generate the noise reduced signal Z to suppress and/or filter motion-induced friction noise included in the input signals X₁, X₂ from the microphones 806. E.g., the noise reduced signal may be generated to dampen components in the first input signal X₁ and/or the second input signal X₂ different from correlated components and/or amplify the correlated components.

Noise canceller 40 may be activated to generate the noise reduced signal Z based on the detection of other types of friction noise, such as wind noise, in addition to motion-induced friction noise. In the illustrated implementation, noise reducing module 1002 further includes a wind noise detector 1006 that is configured to receive the input signals X₁, X₂ from microphones 806 and determine, based on the input signals X₁, X₂, whether the input signals X₁, X₂ include wind noise. For example, wind noise detector 1006 may be configured to measure a correlation of the input signals X₁, X₂, such as at low frequencies. In instances where the correlation falls below a wind threshold, wind noise detector 1006 may determine that the input signals X₁, X₂ include wind noise and activate noise canceller 40 to generate the noise reduced signal Z. For example, noise canceller 40 may generate the noise reduced signal Z to suppress and/or filter wind noise included in the input signals X₁, X₂ from the microphones 806. The noise reduced signal Z may be generated using the same method or algorithm to suppress wind noise and/or motion-induced friction noise. E.g., the noise reduced signal may be generated to dampen components in the first input signal X₁ and/or the second input signal X₂ different from correlated components and/or amplify the correlated components. In some examples, one or more parameters and/or variables of the algorithm are tuned to suppress either wind noise or motion-induced friction noise (e.g., a first set of parameters and/or variables may be used to target the suppression of wind noise, a second set of parameters and/or variables may be used to target the suppression of motion-induced friction noise, a third set of parameters and/or variables may be used to target the suppression of both wind noise and friction noise, etc.).

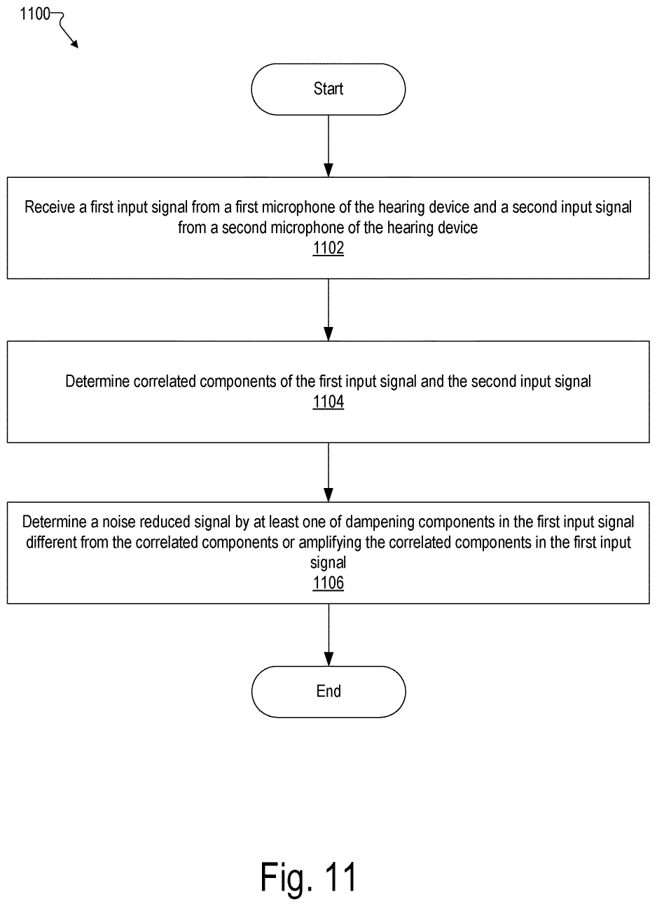

To illustrate, FIG. 11 shows a method 1100 that may be performed by a hearing system to determine a noise reduced signal that suppresses friction noise signals and/or amplifies target signals (e.g., speech) included in input signals. While FIG. 11 illustrates exemplary operations according to one embodiment, other embodiments may omit, add to, reorder, and/or modify any of the operations shown in FIG. 11. One or more of the operations shown in FIG. 11 may be performed by hearing system 800, hearing system 900, hearing system 1000, any components included therein (e.g., computing device 20, noise canceller 40, processing unit 804, processor 814), and/or any implementations thereof. Moreover, each of the operations depicted in FIG. 11 may be performed in any of the ways described herein.

As shown, a hearing system may, at operation 1102, receive a first input signal (e.g., first input signal X₁) from a first microphone (e.g., first microphone) 806-1 of a hearing device (e.g., hearing device 802) and a second input signal (e.g., second input signal X₂) from a second microphone (e.g., second microphone 806-2) of the hearing device. The hearing system is further configured to process the input signals. For example, the input signals may include time domain input signals such that processing the input signals includes converting the input signals into the frequency domain, resulting in a first input signal in the frequency domain from the first microphone and a second input signal in the frequency domain from the second microphone. Both input signals can be seen as vectors composed of complex values, which may be seen as Fourier coefficients of the time domain signals. In some examples, the processing of the input signals is performed in separate sub-bands. In general, the processing may be performed broadband or based on a plurality of frequency bands. In some examples, the cross-correlation, the first auto-correlation, and/or the second auto-correlation are averaged in the frequency domain.

The hearing system may, at operation 1104, determine correlated components of the first input signal and the second input signal. In some examples, the hearing system is configured to determine the correlated components of the first input signal and the second input signal by analyzing statistical relationships between the two signals. To illustrate, for each frequency band, the hearing system may determine a cross-correlation

$$( e . g . , E [ {X}_{1} {X}_{2}^{*} ] )$$

of the two input signals, a first auto-correlation (e.g., E[|X₁|²]) of the first input signal and a second auto-correlation (e.g., E[|X₂|²]) of the second input signal. Based on the cross-correlation and the auto-correlations of the input signals, the hearing system may determine a complex-valued coherent transfer function (e.g., transfer function R), such as by dividing the cross-correlation by a weighted sum of the first auto-correlation and the second auto-correlation. The weighted sum of the first auto-correlation and the second auto-correlation is determined by multiplying the first auto-correlation with a first regularization coefficient (e.g., first regularization coefficient ρ₁) and the second auto-correlation with a second regularization coefficient (e.g., second regularization coefficient ρ₂). The regularization coefficients in the weighted sum may be fixed values and/or may be tuned to suppress wind noise and/or motion-induced friction noise.

A magnitude of the transfer function provides an indication of the degree of correlation between the two input signals at a respective frequency and/or frequency band. For example, frequency components for which the magnitude of the transfer function is relatively high (e.g., on a scale of 0 to 1, the magnitude is greater than about 0.5, such as greater than about 0.75, such as greater than about 0.9, etc.) may be determined to be correlated components (e.g., components likely caused by sound sources that are commonly received by both microphones 806, such as speech or other desired acoustic signals). Conversely, frequency components for which the magnitude of the transfer function is relatively low (e.g., on a scale of 0 to 1, the magnitude is less than about 0.5, such as less than about 0.25, such as less than about 0.1, etc.) are determined to be uncorrelated components (e.g., components likely caused by noise sources that differ between the microphones 806, such as wind noise and/or motion-induced friction noise).

The hearing system may, at operation 1106, determine a noise reduced signal (e.g., noise reduced signal Z) by at least one of dampening components in the first input signal different from the correlated components or amplifying the correlated components in the first input signal. For example, the hearing system may determine a first noise reduced signal (e.g., first noise reduced signal Y₁) by at least one of dampening components in the first input signal different from the correlated components or amplifying the correlated components in the first input signal. The hearing system may additionally determine a second noise reduced signal (e.g., second noise reduced signal Y₂) by at least one of dampening components in the second input signal different from the correlated components or amplifying the correlated components in the second input signal. For example, the first noise reduced signal and the second noise reduced signal are determined by multiplying the first input signal and the second input signal, respectively, with the transfer function.

In some examples, the magnitude of the transfer function is limited from below with a minimal gain and/or limited from above with a maximal gain before multiplication with at least one of the first input signal or the second input signal. For example, for determining the second noise reduced signal, a gain (e.g., gain r) is limited from below to reduce artifacts to a limited gain (e.g., limited gain r_{L}), which may be applied to the second input signal. For determining the first noise reduced signal, the limited gain is further limited from above to an attenuation gain (e.g., attenuation gain r_{A}), which may be applied to the first input signal. In such a way, the gain is limited to attenuation only and/or the projection from the second microphone to the first microphone may be removed for the most part. In general, the magnitude of the transfer function is limited from below with a minimal gain (e.g., minimal gain r_{L}) and limited from above with a maximal gain (e.g., maximal gain r_{H}) before multiplication with the first input signal. For determining the second noise reduced signal, the magnitude of the transfer function is limited from below with the minimal gain.

In some examples, the noise reduced signal is determined by selecting the first noise reduced signal or the second noise reduced signal to output as the noise reduced signal. To illustrate, in a main mode of operation of the hearing system, the second noise reduced signal is selected to output as the noise reduced signal. Accordingly, in the main mode, the second noise reduced signal generated based on the second input signal received from the second microphone (e.g., back microphone 18b) is selected as the noise reduced signal because the second noise reduced signal from the second microphone may be less affected by friction noise than the first noise reduced signal from the first microphone (e.g., front microphone 18a). Because the second noise reduced signal from the second microphone may not always be less affected by friction noise, the hearing system may alternatively, in a fallback mode of operation, select the first noise reduced signal to output as the noise reduced signal.

Still other methods and/or configurations may be used to determine the noise reduced signal. For example, the first noise reduced signal may be selected as the noise reduced signal when the first noise reduced signal has more correlated components than the second noise reduced signal. Conversely, the second noise reduced signal may be selected as the noise reduced signal when the second noise reduced signal has more correlated components than the first noise reduced signal. Alternatively, determining the noise reduced signal may include determining a mixed noise reduced signal to output as the noise reduced signal. The mixed noise reduced signal may include a mix of the first noise reduced signal and the second noise reduced signal. For example, the first noise reduced signal and the second noise reduced signal may be mixed by determining weights for the first noise reduced signal and the second noise reduced signal and summing the first noise reduced signal and the second noise reduced signal weighted with the weights. The weights may be determined based on a power ratio of a first power of the first input signal in at least a frequency band and a second power of the second input signal in at least the frequency band. In some examples, the power ratio is averaged into an averaged power ratio such that the weights are determined from the averaged power ratio.

Method 1100 may further include inputting the noise reduced signal into a sound processor (e.g., sound processor 42) and/or further processing the noise reduced signal into a further processed signal (e.g., further processed signal Z′). Such further processing may include, but is not limited to, one or more of: frequency depending amplification, frequency shifting, frequency compressing, beam forming, or noise cancelling. The further processed signal may further be output to the user of the hearing device via a sound output device (e.g., sound output device 32 and/or output transducer 808).

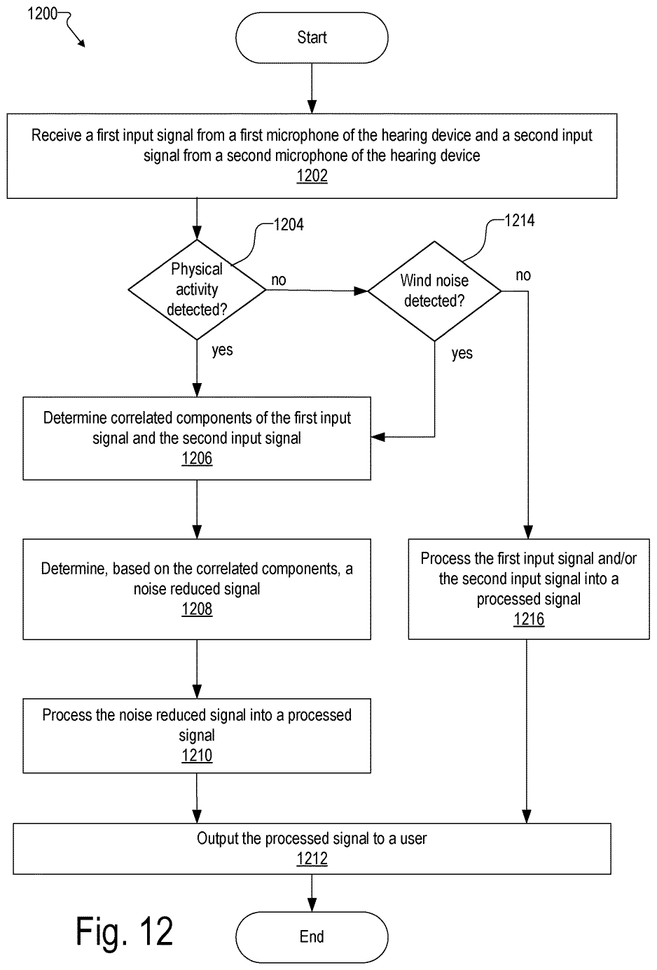

In some examples, the hearing system may be configured to generate the noise reduced signal continuously such that the audio signal output to the user is based on the noise reduced signal during operation of the hearing system. Alternatively, the hearing system may be configured to generate the noise reduced signal intermittently, such as only when friction noise (e.g., wind noise and/or motion-induced noise) is detected. As an illustrative example, FIG. 12 shows a method 1200 that may be performed by a hearing system to determine a noise reduced signal (e.g., noise reduced signal Z) in instances when friction noise is detected. While FIG. 12 illustrates exemplary operations according to one embodiment, other embodiments may omit, add to, reorder, and/or modify any of the operations shown in FIG. 12. One or more of the operations shown in FIG. 12 may be performed by hearing system 800, hearing system 900, hearing system 1000, any components included therein (e.g., computing device 20, noise canceller 40, processing unit 804, processor 814), and/or any implementations thereof. Moreover, each of the operations depicted in FIG. 12 may be performed in any of the ways described herein.

As shown, a hearing system may, at operation 1202, receive a first input signal (e.g., first input signal X₁) from a first microphone (e.g., first microphone 806-1) of a hearing device (e.g., hearing device 802) and a second input signal (e.g., second input signal X₂) from a second microphone (e.g., second microphone 806-2) of the hearing device.

The hearing system may, at operation 1204, determine whether physical activity is detected that is likely to cause motion-induced friction noise. For example, the hearing system may receive a motion signal (e.g., motion signal M) from a motion sensor (e.g., motion sensor 810) included in the hearing device and compare the motion signal with a motion threshold. In instances where the motion signal exceeds the motion threshold, the hearing system may determine that physical activity is detected (e.g., yes, at operation 1204) and proceed with determining a noise reduced signal (e.g., the hearing system may activate noise canceller 40 to generate the noise reduced signal).

To determine the noise reduced signal, the hearing system may, at operation 1206, determine correlated components of the first input signal and the second input signal and, at operation 1208, determine, based on the correlated components, the noise reduced signal. The noise reduced signal may be determined by at least one of dampening components in the first input signal different from the correlated components or amplifying the correlated components in the first input signal and/or by at least one of dampening components in the second input signal different from the correlated components or amplifying the correlated components in the second input signal.

In some examples, the hearing system may further, at operation 1210, process the noise reduced signal into a processed signal (e.g., further processed signal Z′), such as by frequency depending amplification, frequency shifting, frequency compressing, beam forming, and/or noise cancelling. The hearing system may, at operation 1212, output the processed signal to the user via a sound output device (e.g., sound output device 32 and/or output transducer 808).

Alternatively, in instances where the motion signal is less than or equal to the motion threshold, the hearing system may determine that physical activity is not detected (e.g., no, at operation 1204) and, at operation 1214, determine whether wind noise is detected. For example, the hearing system may determine whether wind noise is detected based on the input signals. In instances where correlated components of the input signals fall below a wind threshold, the hearing system may determine that wind noise is detected (e.g., yes, at operation 1214) and proceed with determining the noise reduced signal (e.g., the hearing system may activate noise canceller 40 to generate the noise reduced signal). For example, the hearing system may perform operations 1206-1212. Alternatively, in instances where correlated components of the input signals are equal to or above the wind threshold, the hearing system may determine that wind noise is not detected (e.g., no, at operation 1214) and process the first input signal and/or the second input signal for output to the user (e.g., without activating noise canceller 40 and determining the noise reduced signal). For example, the hearing system may, at operation 1216, process the first input signal and/or the second input signal into a processed signal, such as by frequency depending amplification, frequency shifting, frequency compressing, beam forming, and/or noise cancelling. The hearing system may, at operation 1212, output the processed signal to the user via a sound output device (e.g., sound output device 32 and/or output transducer 808).

Accordingly, in instances where the hearing system detects physical activity and/or wind noise, the hearing system may determine the noise reduced signal to suppress motion-induced friction noise caused by the physical activity and/or the wind noise. Alternatively, in instances where the hearing system fails to detect either physical activity or wind noise, the hearing system may refrain from determining the noise reduced signal (e.g., the hearing system may generate the processed signal based on the first input signal and/or the second input signal at operation 1216). Moreover, the hearing device may continue to receive the first and second input signals (e.g., at operation 1202) and, in instances where the hearing device fails to continue detecting the presence of physical activity and/or wind noise (e.g., the motion signal falls below the motion threshold and/or correlated components of the input signals increase to equal to or above the wind threshold), the hearing system may refrain from determining the noise reduced signal (e.g., deactivate noise canceller 40) and generate the processed signal based on the first input signal and/or the second input signal (e.g., at operation 1216).

Still other methods and/or configurations may be used to suppress friction noise. For example, determining the noise reduced signal may be activated based on analyzing the amplitude and/or frequency content of the input signals in addition to or instead of the motion signal. Additionally or alternatively, the hearing system may use deep neural networks that are trained to identify and remove incoherent sounds between the first input signal and the second input signal, effectively distinguishing unwanted friction noise from the desired audio signal.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”) or static random access memory (“SRAM”), which typically constitutes a main memory. Common forms of computer-readable media include, for example, a disk, hard disk, magnetic tape, any other magnetic medium, a compact disc read-only memory (“CD-ROM”), a digital video disc (“DVD”), any other optical medium, random access memory (“RAM”), programmable read-only memory (“PROM”), electrically erasable programmable read-only memory (“EPROM”), FLASH-EEPROM, any other memory chip or cartridge, or any other tangible medium from which a computer can read. Instructions, as stored in non-volatile memory, are usually first transferred to volatile memory for execution by the processor.

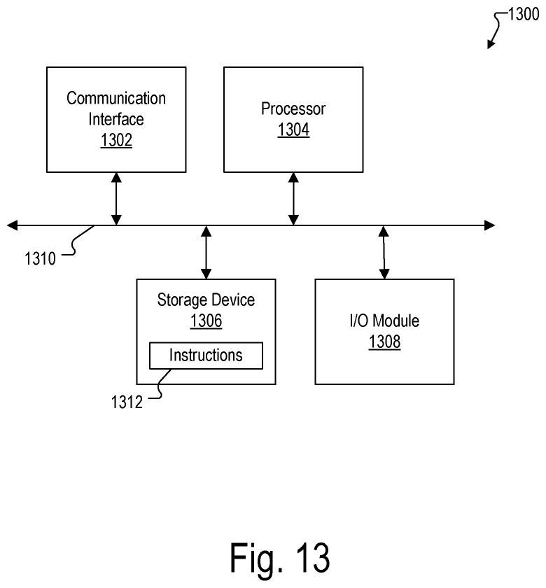

FIG. 13 shows an illustrative computing device 1300 that may be specifically configured to perform one or more of the processes described herein. Any of the systems, computing devices, and/or other components described herein may be implemented by computing device 1300.

As shown in FIG. 13, computing device 1300 may include a communication interface 1302, a processor 1304, a storage device 1306, and an input/output (“I/O”) module 1308 communicatively connected one to another via a communication infrastructure 1310. While an illustrative computing device 1300 is shown in FIG. 13, the components illustrated in FIG. 13 are not intended to be limiting. Additional or alternative components may be used in other embodiments. Components of computing device 1300 shown in FIG. 13 will now be described in additional detail.

Communication interface 1302 may be configured to communicate with one or more computing devices. Examples of communication interface 1302 include, without limitation, a wired network interface (such as a network interface card), a wireless network interface (such as a wireless network interface card), a modem, an audio/video connection, a radio transceiver, and any other suitable interface.

Processor 1304 generally represents any type or form of processing unit capable of processing data and/or interpreting, executing, and/or directing execution of one or more of the instructions, processes, and/or operations described herein. Processor 1304 may perform operations by executing computer-executable instructions 1312 (e.g., an application, software, code, and/or other executable data instance) stored in storage device 1306. Processor 1304 may comprise one or multiple processing devices, e.g. processing cores, with equal and/or different architecture, which may utilize separate (“private”) memory and/or share common memory, e.g. implemented in storage device 1306.

Storage device 1306 may include one or more data storage media, devices, or configurations and may employ any type, form, and combination of data storage media and/or device. For example, storage device 1306 may include, but is not limited to, any combination of the non-volatile media and/or volatile media described herein. Electronic data, including data described herein, may be temporarily and/or permanently stored in storage device 1306. For example, data representative of computer-executable instructions 1312 configured to direct processor 1304 to perform any of the operations described herein may be stored within storage device 1306. In some examples, data may be arranged in one or more databases residing within storage device 1306.

I/O module 1308 may include one or more I/O modules configured to receive user input and provide user output. I/O module 1308 may include any hardware, firmware, software, or combination thereof supportive of input and output capabilities. For example, I/O module 1308 may include hardware and/or software for capturing user input, including, but not limited to, a keyboard or keypad, a touchscreen component (e.g., touchscreen display), a receiver (e.g., an RF or infrared receiver), inertial and/or motion sensors, a touchpad, and/or one or more input buttons.

I/O module 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1308 is configured to provide graphical data to a display for presentation to a user. The graphical data may be representative of one or more graphical user interfaces and/or any other graphical content as may serve a particular implementation.

While the embodiments described herein have been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention from a study of the drawings, the disclosure, and the appended claims. In the claims, the word “comprising” does not exclude other elements or steps, and the indefinite article “a” or “an” does not exclude a plurality. A single processor or controller or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

What is claimed is:

1. A method for noise reduction with a hearing device, the method comprising:
receiving a first input signal from a first microphone of the hearing device and a second input signal from a second microphone of the hearing device;
determining correlated components of the first input signal and the second input signal; and
determining a noise reduced signal by at least one of dampening components in the first input signal different from the correlated components or amplifying the correlated components in the first input signal.

2. The method of claim 1, wherein the determining the noise reduced signal is based on:
receiving a motion signal from a motion sensor included in the hearing device; and
determining that the motion signal exceeds a motion threshold.

3. The method of claim 2, wherein the motion threshold is representative of motion of the hearing device when a user of the hearing device is walking.

4. The method of claim 2, wherein the motion sensor includes an accelerometer.

5. The method of claim 1, wherein the determining the noise reduced signal is based on detecting wind noise using a wind noise detector.

6. The method of claim 1, further comprising:
determining a first noise reduced signal by at least one of dampening components in the first input signal different from the correlated components or amplifying the correlated components in the first input signal; and
determining a second noise reduced signal by at least one of dampening components in the second input signal different from the correlated components or amplifying the correlated components in the second input signal.

7. The method of claim 6, wherein the determining the noise reduced signal comprises selecting the first noise reduced signal or the second noise reduced signal to output as the noise reduced signal.

8. The method of claim 7, wherein, in a main mode, the second noise reduced signal is selected to output as the noise reduced signal.

9. The method of claim 7, wherein, in a fallback mode, the first noise reduced signal is selected to output as the noise reduced signal.

10. The method of claim 7, wherein the selecting the first noise reduced signal or the second noise reduced signal includes selecting the first noise reduced signal when the first noise reduced signal has more correlated components than the second noise reduced signal or selecting the second noise reduced signal when the second noise reduced signal has more correlated components than the first noise reduced signal.

11. The method of claim 6, wherein the determining the noise reduced signal comprises determining a mixed noise reduced signal to output as the noise reduced signal, wherein the determining the mixed noise reduced signal includes mixing the first noise reduced signal and the second noise reduced signal.

12. The method of claim 11, further comprising:
mixing the first noise reduced signal and the second noise reduced signal by: determining weights for the first noise reduced signal and the second noise reduced signal; and
summing the first noise reduced signal and the second noise reduced signal weighted with the weights.

13. The method of claim 1, further comprising:
determining a first auto-correlation of the first input signal, a second auto-correlation of the second input signal and a cross-correlation between the first input signal and the second input signal;
determining a transfer function by dividing the cross-correlation by a weighted sum of the first auto-correlation and the second auto-correlation; and
determining the noise reduced signal by multiplying the first input signal and/or the second input signal with the transfer function.

14. The method of claim 13,
wherein a magnitude of the transfer function is limited from below with a minimal gain before multiplication with at least one of the first input signal or the second input signal.

15. The method of claim 13, further comprising:
determining a first noise reduced signal by multiplying the first input signal with the transfer function, wherein a magnitude of the transfer function is limited from below with a minimal gain and limit from above with a maximal gain before multiplication with the first input signal; and
determining a second noise reduced signal by multiplying the second input signal with the transfer function, wherein a magnitude of the transfer function is limited from below with a minimal gain.

16. The method of claim 1, wherein the first microphone is a front microphone and the second microphone is a back microphone of the hearing device.

17. The method of claim 1, further comprising:
further processing the noise reduced signal into a further processed signal and outputting the further processed signal to a user of the hearing device;
wherein further processing comprises at least one of:
frequency depending amplification;
frequency shifting and/or frequency compressing;
beam forming; or
noise cancelling.

18. A computer program for noise reduction with a hearing device, which, when being executed by a processor, is adapted to carry out the steps of:
receiving a first input signal from a first microphone of the hearing device and a second input signal from a second microphone of the hearing device;
determining correlated components of the first input signal and the second input signal; and
determining a noise reduced signal by at least one of dampening components in the first input signal different from the correlated components or amplifying the correlated components in the first input signal.

19. A hearing system, comprising:
a first microphone and a second microphone;
a noise canceller configured to:
receive a first input signal from the first microphone and a second input signal from the second microphone;
determine correlated components of the first input signal and the second input signal; and
determine a noise reduced signal by at least one of dampening components in the first input signal different from the correlated components or amplifying the correlated components in the first input signal;
a sound processor configured to further process the noise reduced signal into a further processed signal; and
a sound output device configured to output the further processed signal to a user of the hearing device.

20. The hearing system of claim 19, further comprising a motion sensor, wherein the noise canceller is further configured to:
receive a motion signal from the motion sensor; and
compare the motion signal to a motion threshold, wherein the noise reduced signal is determined when the motion signal exceeds the motion threshold.
